(19) United States
(12) Patent Application Publication
(10) Pub. No.: US 2016/0027562 A1
(43) Pub. Date: Jan. 28, 2016

(54) PRECISION RESISTOR TUNING AND TESTING BY INKJET TECHNOLOGY

(71) Applicant: QUALCOMM Incorporated, San Diego, CA (US)

(72) Inventors: Yuan FENG, San Diego, CA (US); Kyu-Pyung HWANG, San Diego, CA (US); Xiaoming CHEN, San Diego, CA (US)

(21) Appl. No.: 14/340,542

(22) Filed: Jul. 24, 2014

(51) Int. Cl. H01C 17/065; H01C 1/012; H01C 1/14; H01C 7/00

(52) U.S. Cl. CPC H01C 17/065; H01C 7/003; H01C 1/012; H01C 1/14

(57) ABSTRACT

A method of additive tuning a resistor includes measuring resistance across a recessed area of the resistor using at least two terminals, depositing resistance material from an ink jet across the recessed area of the resistor device concurrently with the measuring resistance, and ceasing the depositing upon obtaining a measurement of a resistance threshold value.

### BACKGROUND

1. Field

The present disclosure relates generally to a resistor device, and more particularly, to additive tuning of the resistor device.

2. Background

Metal film resistors are typically used in circuits where stability, accuracy and reliability are important. A thin metal film provides the resistive element. Currently, one way of testing metal film resistors during fabrication is limited to discrete incremental adjustments. Portions of resistive material are cut away in discrete sized chunks with a laser to achieve the desired resistance value. This results in resistors lacking a fine precision of resistance.

### SUMMARY

A method of additive tuning a resistor includes measuring resistance across a recessed area of the resistor using at least two terminals, depositing resistance material from an ink jet across the recessed area of the resistor device concurrently with the measuring resistance, and ceasing the depositing upon obtaining a measurement of a resistance threshold value.

A precision resistor includes a substrate and a frame on a top surface of the substrate at least two terminals located at opposite ends of the frame. An amount of resistance material is deposited across the recessed area by an ink jet spray. The amount of resistance material is additively controlled by concurrently measuring resistance across the at least two terminals.

### BRIEF DESCRIPTION OF THE DRAWINGS

FIG. 1A is a block diagram illustrating a top view of an example resistor device.

FIG. 1B is a block diagram illustrating a side sectional view of the example resistor device of FIG. 1A.

FIG. 2A is a block diagram of an example resistor device with additive tuning.

FIG. 2B shows a top view of an example resistor device after additive tuning is completed.

FIG. 3 is a block diagram of an example method for additive tuning of a resistor device.

FIG. 4 is diagram of a resistor device for an example of strip size control during additive tuning.

FIG. 5 is a diagram of a resistor device for an example spray pattern.

FIG. 6 is a block diagram of an example processor system for controlling additive tuning of a resistor device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a precision resistor tuning and testing using ink jet depositing will now be presented with reference to various apparatus and methods. These apparatus and methods will be described in the following detailed description and illustrated in the accompanying drawings by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

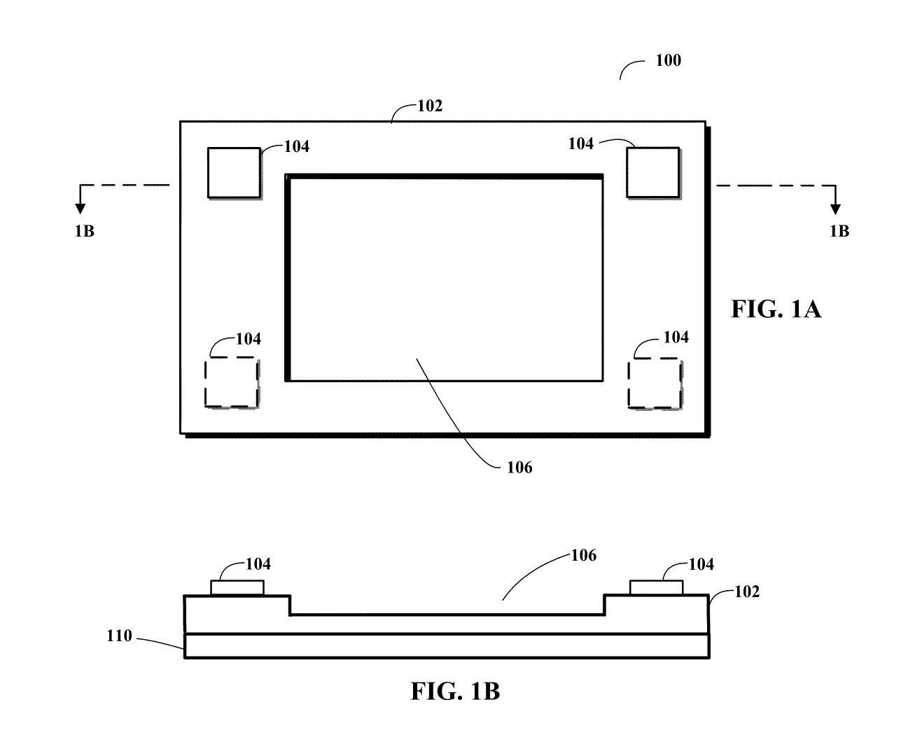

FIG. 1A is a block diagram illustrating a top view of an example resistor device 100 having a frame 102, a recessed area 106, and at least two contact pads 104. FIG. 1B is a block diagram illustrating a side sectional view of the example resistor device 100, showing a substrate 110 under the frame 102, contact pads 104 and recessed area 106. The resistor device may be a high precision resistor chip with an area, for example, that is less than 1.5 mm². While the example device described below relates to a resistor, similar techniques may be employed to fabricate a capacitor or an inductor. The substrate 110 may be ceramic or other equivalent non-conductive, inert material or composite. FIG. 1A shows two additional contact pads 104 with dashed lines as optional elements for the resistor device 100, depending on the number of independent terminations required and/or a number of measurement probes to be connected to the device. The frame 102 may be metal or other conductive material or composite, including semi-conductive material. The recessed area 106 may be adapted to a depth for accepting a deposit of resistor material (e.g., metal, conductive, or semi-conductive material or composite), in an amount that provides a desired resistance value across the resistor device 100.

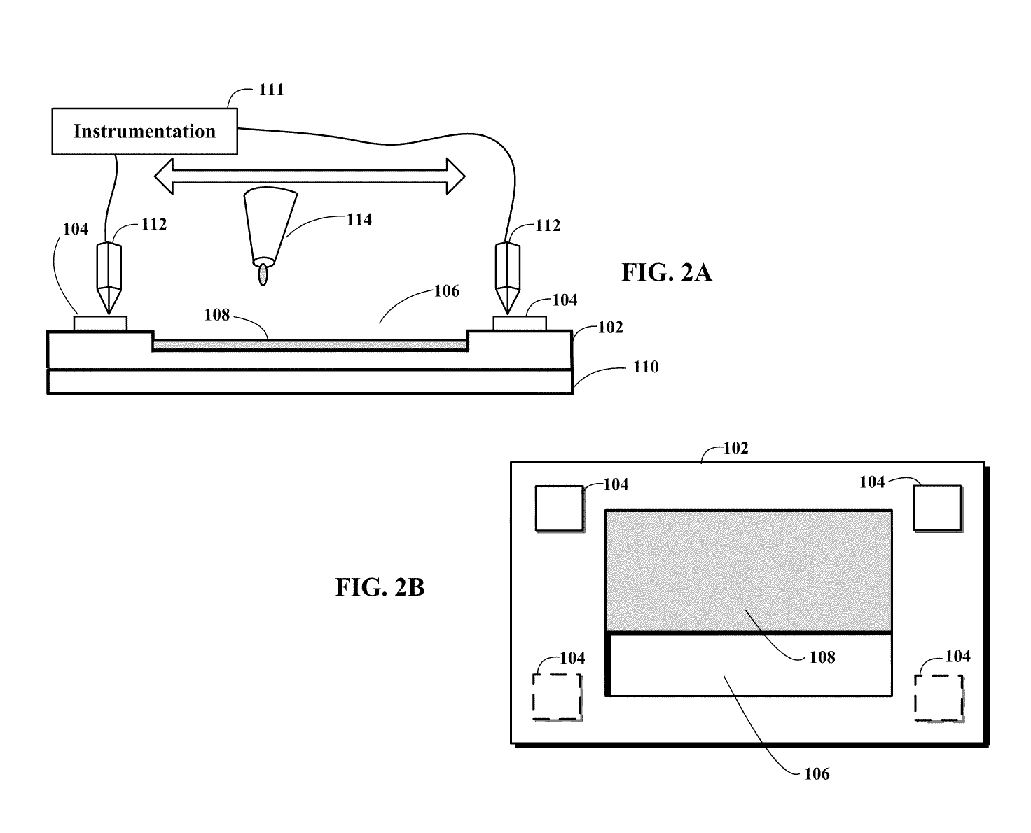

FIG. 2A is a block diagram of an example resistor device with additive tuning by depositing a resistor material 108. An ink jet 114 may be adapted to pass from side to side while spraying droplets of resistor material 108, to form a strip of resistor material within the recessed area 106 with each pass. Instrumentation 111 may include at least two resistor probes 112 for connection at the contact pads 104 to continuously measure resistance across the resistor device 100 concurrently with the depositing of resistor material 108 by the ink jet 114. An example of instrumentation 111 is an ohmmeter, an ammeter and/or a voltmeter. The probes 112 may be configured as Kelvin four-wire probes.

FIG. 2B shows a top view of the resistor device 100 after the additive tuning is completed according to an example deposit configuration of resistor material 108. The ink jet 114 ceases spraying the droplets precisely when the instrumentation 111 measures a threshold resistance as specified for the resistor device 100. As shown, the resistor device 100 may be formed having resistor material 108 partially covering the recessed region 106. Alternatively, the threshold resistance may be such that the ink jet 114 continues to spray droplets of resistor material 108 for enough passes to cover the recessed region 106 entirely. Alternatively, the ink jet 114 may further continue to spray droplets of the resistor material 108 across the recessed region 106 to form two or more layers of resistor material in the recessed region 106.

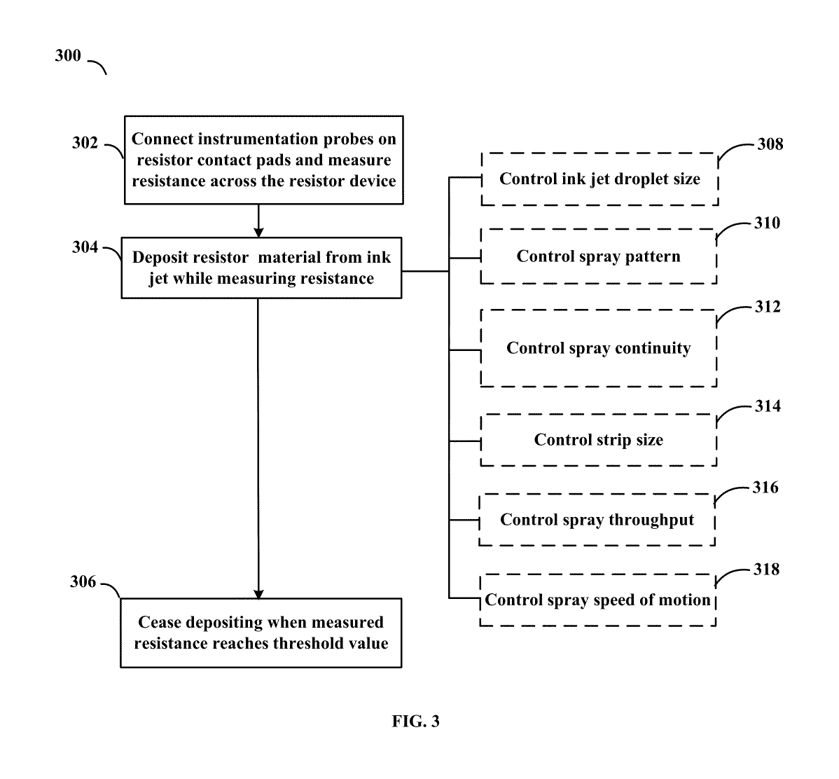

FIG. 3 shows a flow diagram of an example method 300 for additive tuning of the resistor device 100. At 302, the probes 112 for instrumentation 111 are connected to the resistor contact pads 104 and resistance is measured across the resistor 100. At 304, the ink jet 114 deposits the resistor material 108 while the instrumentation 111 measures the resistance. At 306, the ink jet 114 ceases the depositing of resistor material 108 when the measured resistance reaches a specified threshold value. There may be a tolerance range specified for the threshold resistance value.

The depositing of resistor material by the ink jet 114 may be controlled in at least one of various ways as shown in FIG. 3. At 308, the ink jet 114 may be controlled to adjust droplet size of the spray. For example, as the measured resistance approaches the threshold value, the droplet size may be reduced to provide finer resolution of resistance measurement as the spray is terminated by the ink jet 114. At 310, the ink jet 114 may be controlled to adjust the spray pattern across the recessed region. For example, in a case where several layers of strips are to be sprayed, the ink jet 114 may spray in both directions to cover the entire recessed region more rapidly, followed by spraying only in one direction for the final passes as the resistance threshold value is approached, to allow proper timing coordination with the instrumentation 111 for the termination point. As another example, the spray pattern may follow a pattern that first covers the perimeter of the recessed region, followed by the interior of the recessed region 106. The ink jet 114 may also be controlled at 312 by continuous spray or discontinuous spray (e.g., spray pulsing) as needed to synchronize with the resistance measurements and to refine the resistance measurement resolution during the depositing. At 314, the ink jet 114 may be controlled to lay down adjustable strip sizes. For example, as the resistance measurement approaches the resistance threshold value, the ink jet 114 may spray a finer strip of resistance material 108. Alternatively, the ink jet 114 may further refine one or more subsequent strips of resistance material until the resistance threshold value is reached.

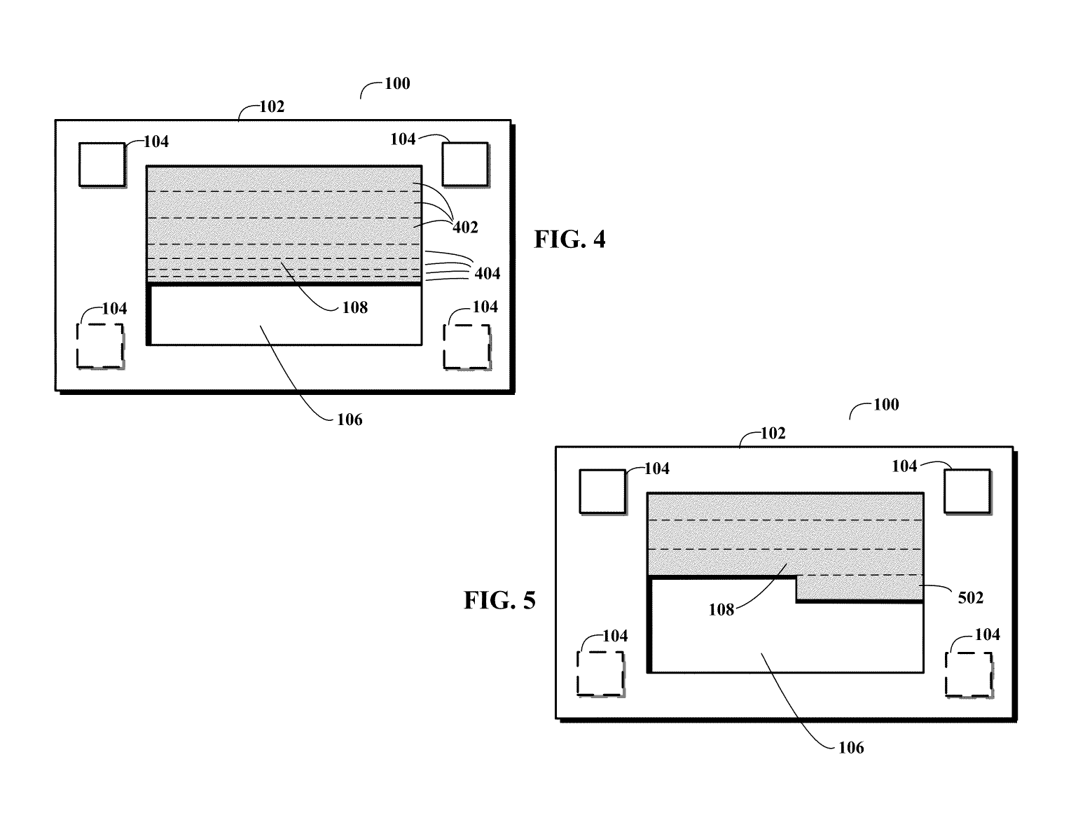

FIG. 4 is a diagram of a resistor device 100 for an example of the strip size control for the deposited resistance material 108 during additive tuning. As shown, uniform strips 402 are laid down by the ink jet 114, followed by narrowing strips 404 until the resistance threshold value is measured by instrumentation 111.

Returning to FIG. 3, at 316, the ink jet 114 may control the spray throughput during the depositing of the resistance material 108. For example, the ink jet 114 may begin with an initial spray throughput, and then make one or more adjustments a lower spray throughput as the resistance threshold value is approached. The ink jet 114 may also be controlled at 318 by controlling the speed of motion while passing across the recessed region 106, either moving faster or slower when spanning the recessed region 106.

FIG. 5 is a diagram of a resistor device 100 for an example spray pattern by the ink jet 114 in which the last strip 502 only partially spans the recessed region. This may occur as the ink jet 114 has additively deposited enough resistance material 108 and then is abruptly terminated to avoid exceeding the resistance threshold value for the resistor device 100.

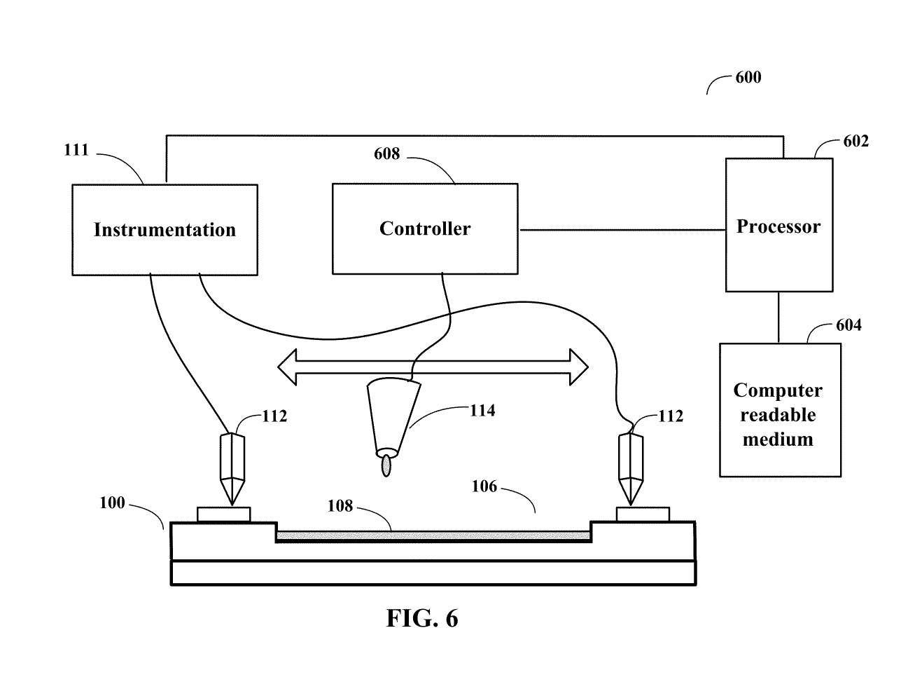

FIG. 6 is a block diagram of an example processor system 600 for controlling additive tuning of the resistor device 100. A processor 602 is coupled to a computer readable medium 604 which may have executable instructions stored for execution by the processor 602, which control the ink jet 114 in conjunction with the measured resistance by instrumentation 111. The processor 602 is coupled to a controller 608, which operates the ink jet 114 by controlling its motion as it spans the recessed area 106, and by controlling the spray of the ink jet according to the various manners as described above.

In an aspect of the present invention, an example system may include an ink jet 114, instrumentation 111 for measuring a resistance value across a resistor device, a controller 608 coupled to the ink jet 114, a processor 602 adapted to send instructions to the controller based on measured resistance values received from the instrumentation 111, and a computer readable medium 604 having stored executable instructions, that when execute by the processor 602, perform the following steps: measuring resistance across a recessed area of the resistor device 100 using at least two terminals 104; depositing resistance material 108 from an ink jet 114 across the recessed area 106 of the resistor device 100 concurrently with the measuring resistance; and ceasing the depositing upon obtaining a measurement of a resistance threshold value.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of additive tuning a resistor, comprising:
measuring resistance across a recessed area of a resistor device using at least two terminals;
depositing resistance material from an ink jet across the recessed area of the resistor device concurrently with the measuring resistance; and
ceasing the depositing upon obtaining a measurement of a resistance threshold value.

2. The method of claim 1, further comprising controlling droplet size from the ink jet to increase resolution of the measured resistance as the measured resistance approaches the resistance threshold value.

3. The method of claim 1, further comprising controlling a spray pattern during the depositing.

4. The method of claim 1, further comprising controlling continuity of spray during the depositing.

5. The method of claim 1, further comprising controlling the ink jet spray to apply finer strips of resistance material as the measured resistance approaches the resistance threshold value.

6. The method of claim 1, further comprising controlling spray throughput of the ink jet, wherein the spray throughput is reduced as the measured resistance approaches the resistance threshold value.

7. The method of claim 1, further comprising controlling speed of motion for the ink jet during the applying of the material.

8. The method of claim 1, wherein the measuring comprises using a four point Kelvin probing device.

9. The method of claim 1, wherein the ceasing occurs with the ink jet having deposited at least one strip of resistance material only partially spanning the recessed area.

10. A resistor, comprising:
a substrate;
a frame on a top surface of the substrate, the frame having a recessed area;
at least two terminals located at opposite ends of the frame; and
an amount of resistance material deposited across the recessed area by an ink jet spray, the amount additively controlled by concurrently measuring resistance across the at least two terminals.

11. The resistor of claim 10, wherein the amount of resistance material is deposited by controlling droplet size from the ink jet to increase resolution of the measured resistance as the measured resistance approaches the resistance threshold value.

12. The resistor of claim 10, wherein the amount of resistance material is deposited by controlling a pattern of the spray.

13. The resistor of claim 10, wherein amount of resistance material is deposited by controlling continuity of the spray.

14. The resistor of claim 13, wherein the amount of resistance material is deposited with a spray pattern refined by finer strips as the measured resistance approaches the predetermined threshold value.

15. The resistor of claim 10, wherein the amount of metallic material is deposited by controlling throughput of the ink jet, wherein the throughput is reduced as the measured resistance approaches the predetermined threshold value.

16. The resistor of claim 10, wherein the amount of resistance material is deposited while controlling speed of motion for the ink jet.

17. The resistor of claim 10, wherein the measuring includes using a four-wire Kelvin probe.

18. The resistor of claim 10, wherein the amount of metallic material is deposited with at least one strip of resistance material only partially spanning the recessed area.

19. A system comprising:
an ink jet;
instrumentation for measuring a resistance value across a resistor device;
a controller coupled to the ink jet;
a processor adapted to send instructions to the controller based on measured resistance values received from the instrumentation; and
a computer readable medium having stored executable instructions, that when executed by the processor, perform the following steps:
measuring resistance across a recessed area of the resistor device using at least two terminals;
depositing resistance material from an ink jet across the recessed area of the resistor device concurrently with the measuring resistance; and
ceasing the depositing upon obtaining a measurement of a resistance threshold value.
